(19) United States
(12) Patent Application Publication
(10) Pub. No.: US 2025/0328483 A1
(43) Pub. Date: Oct. 23, 2025

(54) SYSTEM AND METHOD FOR MULTI-CORE ACCESS CONTROL ON A DUAL-CORE MICROCONTROLLER

(71) Applicant: Microchip Technology Incorporated, Chandler, AZ (US)

(72) Inventors: Eric Ching, Austin, TX (US); Xin Zhang, Austin, TX (US); Phil Li, Palo Alto, CA (US); Matthew Fernsler, Cedar Park, TX (US); Michael Rentschler, Karlsruhe (DE)

(21) Appl. No.: 19/183,680

(22) Filed: Apr. 18, 2025

Related U.S. Application Data
(60) Provisional application No. 63/636,370, filed on Apr. 19, 2024.

(51) Int. Cl. G06F 13/40; G06F 1/26

(52) U.S. Cl. CPC G06F 13/4027; G06F 1/266

(57) ABSTRACT

A method includes powering up a privileged core while leaving an unprivileged core unpowered, the privileged core and the unprivileged core respectively of a microcontroller, configuring a hardware-based mechanism of access control for the unprivileged core, the configuring at least partially based on control parameters that define access to resources by the unprivileged core; and powering up the unprivileged core, operation of the unprivileged core subject to the hardware-based mechanism of access control.

### CROSS-REFERENCE TO RELATED APPLICATIONS

This application claims the benefit under 35 U.S.C. § 119(e) of U.S. Provisional Patent Application Ser. No. 63/636,370, filed Apr. 19, 2024, the disclosure of which is hereby incorporated herein in its entirety by this reference.

### TECHNICAL FIELD

One or more examples relate, generally, to dual-core microcontroller systems, and more specifically, to access control to resources shared by processing cores of the dual-core microcontroller system. One or more examples relate, generally, to a secure execution zone in a dual-core microcontroller.

### BACKGROUND

Resources are sometimes shared by processing cores in a dual-core microcontroller (MCU) system.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting an apparatus to control access to resources by a processing core (“core”) of a dual-core system, in accordance with one or more examples;

FIG. 2 is a system architecture diagram depicting an example system of a portion of an MCU having a dual-core architecture and integrated access control subsystem, in accordance with one or more examples;

FIG. 3 is a schematic diagram depicting example bus matrix interconnections for access control, in accordance with one or more examples;

FIG. 4 is a flow diagram depicting an example process to set access control by a processing core of a dual-core microcontroller, in accordance with one or more examples;

FIG. 5 is a flow diagram depicting an example process to configure a hardware-based mechanism of access control for the unprivileged core based on control parameters, in accordance with one or more examples;

FIG. 6 is a flow diagram depicting an example process to configure a hardware-based mechanism of access control at least partially based on control parameters that define access to resources by the unprivileged core, in accordance with one or more examples;

FIG. 7 is a block diagram depicting a system implementing a secure execution zone, in accordance with one or more examples;

FIG. 8 illustrates an example process for resource assignment integrated with a secure execution zone, in accordance with one or more examples; and

FIG. 9 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” “greater,” “lesser,” “higher,” or “lower” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless the context clearly indicates otherwise.

Multi-core access control is a design consideration within microcontroller units (MCUs) that include multiple processing cores (“cores”). It arises from the requirement to manage shared resources—such as memory, peripherals, interrupts, semaphores, and input/output interfaces (e.g., general purpose input/output (GPIO), busses, without limitation), without limitation—in a secure and efficient manner. A multi-core access control system should ensure security and maintaining system integrity while leveraging the concurrent processing capabilities of a multi-core system.

The terms “microcontroller,” “microcontroller unit,” and “MCU” are used herein to mean “microcontroller.” Use of the term “unit” is used for clarity and convenience in understanding the disclosure and accompanying drawings and does not indicate preference for a complete, self-contained module that provides all the necessary components for microcontroller functionalities in one package except unless the context clearly indicates otherwise.

When multiple cores have the potential to access and modify the same resources, there is a risk of contention or conflicting access. This can lead to system errors, data corruption, and breaches of security. For instance, one core might be in the midst of a write or read to a peripheral register when another core attempts a write or read to the same register. Without proper access control, such simultaneous operations could result in indeterminate states and behaviors, which are unacceptable, particularly in safety-critical applications.

In a dual-core microcontroller, specific cores and resources may be designated for specific tasks that have different levels of security. A first core might handle sensitive tasks, while a second, different core might handle less-sensitive tasks. Ensuring that the unprivileged core cannot access or alter the operations of the privileged core is paramount to maintaining system security.

Assigning ownership or priority for specific resources (e.g., peripherals, interrupts, memory, I/O interfaces, semaphores, busses, without limitation) of a microcontroller to a specific core allows for structured management and predictable operation of those resources. It prevents conflicts and ensures that resource access is synchronized across the system.

As a non-limiting example, interrupt signals should be directed appropriately to ensure the right core responds to specific events. Effective interrupt sharing mechanisms manage interrupt signals without causing priority inversion or missed interrupts.

As a further non-limiting example, semaphores (e.g., hardware semaphores, without limitation) are used as signaling mechanisms to control access to resources shared by cores. In a multi-core environment, semaphores help prevent race conditions where two cores try to access a resource simultaneously, leading to potential data corruption.

As a further non-limiting example, sometimes it is necessary to delineate which parts of the memory are accessible by which cores. This can involve dividing the memory (e.g., volatile or non-volatile memory, without limitation) into partitions that are exclusively accessible by a specific core or setting up shared regions with appropriate access rights.

As a further non-limiting example, sometimes multi-core systems control which core can access which buses or portions of buses, such as a system bus (e.g., the Advanced High-performance Bus (AHB), without limitation) or peripheral bus (e.g., Advanced Peripheral Bus (APB), without limitation).

One or more examples relate, generally, to a system to manage operations between two or more cores, a privileged core and one or more subordinate ‘unprivileged’ cores, each with designated levels of access to resources of a microcontroller. In one or more examples, the privileged core is responsible for the initial configuration of access control for resources of a microcontroller. One or more hardware-based mechanisms for access control are pre-configured to prevent an unprivileged core from accessing specific resources without requiring the unprivileged core to first request access or take another action. This ensures that system integrity is maintained and that the unprivileged core may operate within a controlled environment without compromising the overall system security.

Multi-core access control technique discussed herein include a dual-core microcontroller architecture that integrates advanced mechanisms to arbitrate and control access to shared resources such as memory, peripherals, and communication buses.

As used herein, the term “dual-core” is not intended to indicate a preference for, or limit this disclosure to, systems with two cores. Examples may be utilized in systems with two cores, or more than two cores. The term “dual-core” should be understood to mean “two or more cores” unless explicitly stated otherwise or the context clearly indicates otherwise.

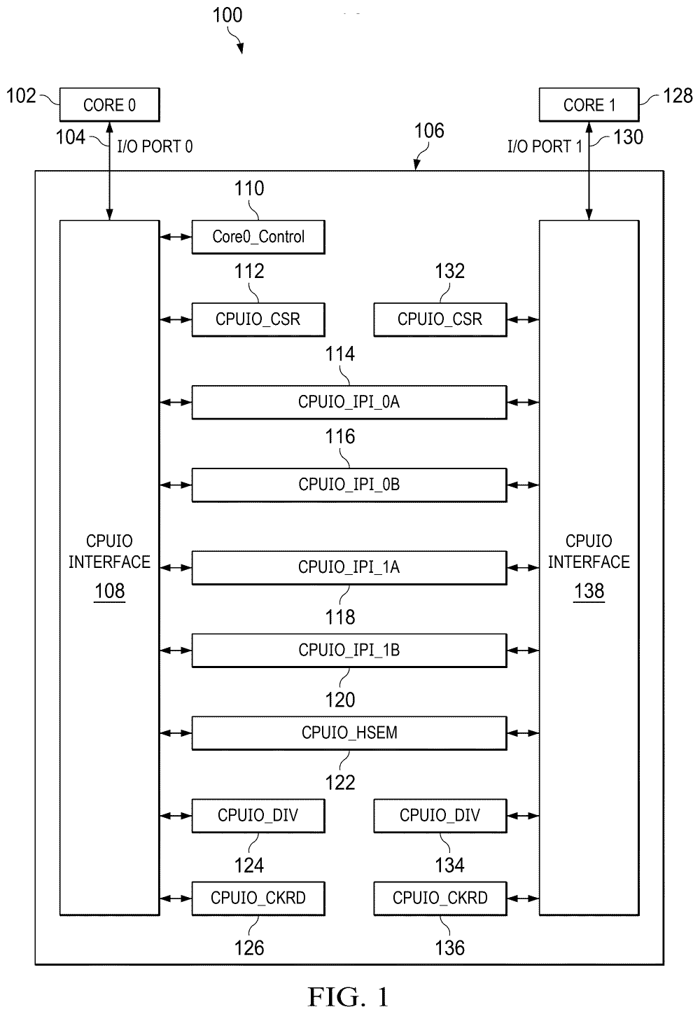

FIG. 1 is a block diagram depicting a system 100 to control access to resources by a processing core (“core”) of a dual-core system, in accordance with one or more examples.

The system 100 depicted by the block diagram of FIG. 1 is a portion of a system (e.g., a microcontroller, without limitation) having a dual-core architecture and an integrated access control subsystem. In one or more examples, the system may be part of a system-on-chip (SoC) design that integrates various components required for its operation, such as processing units, memory controllers, communication buses, and peripherals.

The portion of the system depicted by the block diagram includes Core 0 102, Core 1 128, and a CPUIO peripheral 106 that is directly managed or interfaced by Core 0 102 and Core 1 128 via a CPUIO subsystem.

Core 0 102 and Core 1 128 are central processing units (CPUs) within the system. The CPUIO peripheral 106 is an interface through which Core 0 102 and Core 1 128 may interact with various sub-modules of the CPUIO peripheral 106. CPUIO peripheral 106 includes various registers (e.g., configuration registers, control registers, status registers, and combinations thereof, without limitation) and mechanisms that define permissible actions for each core on the resources of the system (e.g., peripherals, memory, interrupts, semaphores, I/O interfaces, without limitation) as discussed below. An access control subsystem is integrated with the CPUIO peripheral 106 and specific sub-modules thereof. The access control subsystem manages how multiple cores—in this specific example, Core 0 102 (privileged) and Core 1 128 (unprivileged)—interact with shared resources of a larger system (larger system not depicted by FIG. 1). The access control subsystem ensures secure and efficient operation in multi-core environments. In one or more examples, the access control subsystem may define and enforce access policies and maintain the functional isolation of processor cores within the SoC.

Within the access control subsystem, Core 0 102 acts as the central authority (also referred to herein as a “privileged core”), having privileged, and optionally exclusive, control over some or a totality the configuration of system resources and determining the access rights of other cores, including Core 1 128. Core 0 102 has higher privileges and is responsible for initializing the system, configuring access control, and optionally managing the boot process of Core 1 128. Core 1 128, while capable of executing code and performing tasks, its access to resources is managed and restricted based on the configurations set by Core 0 102, as discussed below. In one or more examples, an “unprivileged core” does not have the same privileges to control access to system resources or determine access rights of other cores that are held by a privileged core. Example mechanisms for designating a privileged core are discussed below.

During the system's initial boot sequence, the privileged core, Core 0 102, is the first core to power on and execute. This allows Core 0 102 to set up access control specified by Core0_Control 110 before any other cores power on. By the time the other cores power on, the access control configuration is already set by Core 0 102.

In one or more examples, the CPUIO peripheral 106 includes: CPUIO interface 108, CPUIO Interface 138, Core0_Control 110, CPUIO_CSR 112, CPUIO_CSR 132, CPUIO_IPI_0A 114, CPUIO_IPI_0B 116, CPUIO_IPI_1A 118, CPUIO_IPI_1B 120, CPUIO_HSEM 122, CPUIO_DIV 124, CPUIO_DIV 134, CPUIO_CKRD 126, and CPUIO_CKRD 136.

The CPUIO interface 108 and CPUIO Interface 138 are interfaces that Core 0 102 and Core 1 128 use to communicate with the CPUIO peripheral 106. The CPUIO interface 108 and CPUIO Interface 138 serve as the communication channel through which data and control signals are exchanged between Core 0 102 and Core 1 128 and sub-modules of the CPUIO peripheral 106. Although CPUIO interface 108 and CPUIO Interface 138 are depicted and labeled as two separate interface blocks by FIG. 1, that is merely for clarity and convenience in understanding the disclosure. CPUIO interface 108 and CPUIO Interface 138 may be different interface blocks or of the same interface block that includes both I/O port0 104 (a “first port”) and I/O Port1 130 (a “second port”).

In the specific example depicted by FIG. 1, Core 0 102 is connected to I/O Port0 104 of a CPUIO interface 108 and Core 1 128 is connected to I/O Port1 130 of the CPUIO Interface 138. I/O Port0 104 and I/O Port1 130 are specific ports within the CPU IO interface that are dedicated for exclusive use by Core 0 102 or Core 1 128, respectively. Use dedicated ports allows for organized, direct, and efficient interaction between respective cores and the peripherals and sub-modules connected via the CPUIO interface 108 and CPUIO Interface 138.

I/O port0 104 and I/O Port1 130 are designated to respective specific cores (here, Core 0 102 and Core 1 128, respectively) to ensure that the communications and I/O operations are handled independently and without interference. The separation ensures that the cores Core 0 102 and Core 1 128 can perform different tasks or have different security levels. Here, CPUIO interface 108 allows communication with Core0_control 110 (discussed below) exclusively via I/O port0 104, and so the core connected to I/O port0 104, which is Core0, can communicate with Core0_control 110.

CPUIO_CKRD 126 and CPUIO_CKRD 136 are respectively clock read registers involved in timekeeping functions, providing the ability to read system clocks or timers directly, facilitating time-stamped operations or time-sensitive task scheduling.

CPUIO_DIV 124 and CPUIO_DIV 134 are respectively a hardware divider to perform arithmetic operations that are needed frequently by Core 0 102 or Core 1 128, configured for speed and directly accessible by Core 0 102 and Core 1 128.

CPUIO_HSEM 122 includes one or more hardware semaphores to manage access to shared resources within the multi-core environment to prevent race conditions and ensure proper synchronization between tasks running on Core 0 102 and Core 1 128 so that Core 0 102 and Core 1 128 do not simultaneously access the same resource in a manner that might cause conflict or corrupt data.

CPUIO_IPI_0A 114, CPUIO_IPI_0B 116, CPUIO_IPI_1A 118, CPUIO_IPI_1B 120 are respectively Inter-Processor Interrupts (IPIs) used to manage inter-processor communications between different cores (e.g., Core0, Core1, without limitation). These IPI's facilitate signaling and synchronization between cores, helping manage tasks and data coherently across the system.

CPUIO_CSR 112 and CPUIO_CSR 132 are control and status registers used to provide status updates from the CPUIO peripheral 106 (and the access control subsystem) to Core 0 102 and Core 1 128, respectively, and receive control signals from Core 0 102 and Core 1 128 for components of CPUIO peripheral 106. Such status updates and control signals may include configuration settings, status reporting, and command execution controls.

Core0_Control 110 is a set of control registers of CPUIO Peripheral 106 that are dedicated to the CPUIO port of Core 0 102. Core0_control 110 provides the logic and data (e.g., control parameters, without limitation) of the access control subsystem. In one more example, Core0_control 110 provides Core 0 102 with a set of control registers to manage access permissions for different system resources. Core0_Control 110 may include hardware-based control mechanisms of the access control subsystem which are embodied in control registers. Such control registers allow Core 0 102 to configure and manage system settings that govern the behavior of other cores and system components, as discussed below.

For example, Core0_Control 110 handles the boot-up sequence for unprivileged cores. Core0_control 110 may delay the booting of unprivileged cores until necessary system configurations and security measures are established by Core 0 102. This control over the boot process prevents any premature execution of code on other cores that might compromise the system.

In one or more examples, control registers specific to Core0_Control 110 are accessible only by Core 0 102. These registers might include configurations for system boot, peripheral access, memory management, and security settings. In one or more examples, other cores (i.e., unprivileged cores) either do not have the necessary hardware lines to access these registers or are explicitly blocked by hardware security mechanisms, discussed herein.

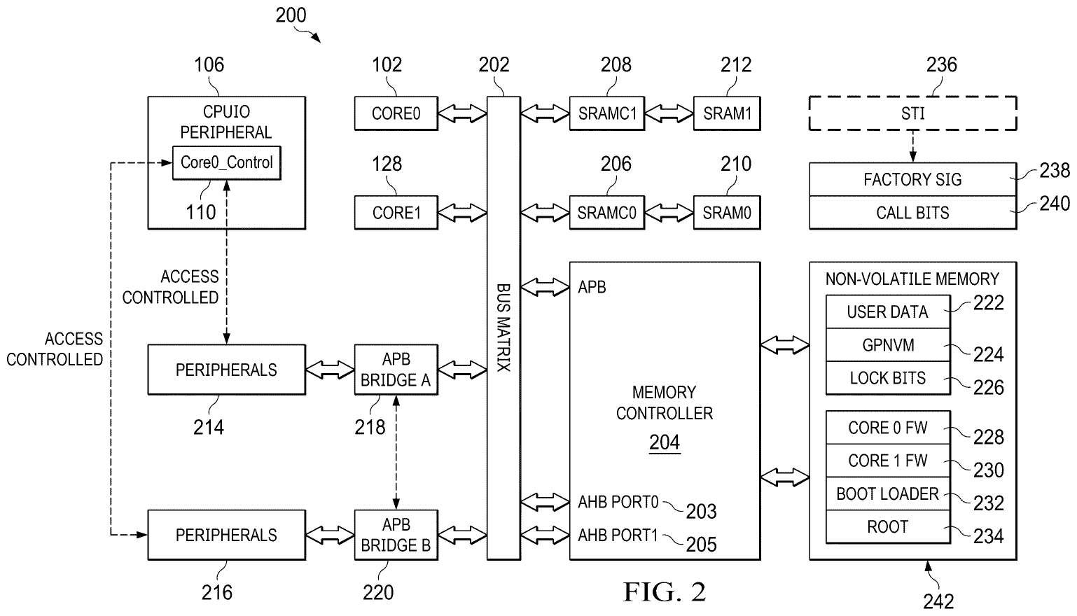

In one or more examples, one or more hardware-based mechanisms of the access control subsystem are integrated with control registers of Core0_control 110. As non-limiting examples, hardware-based mechanisms may include peripheral bus access control, (e.g., APB bus, without limitation), system bus (e.g., AHB bus, without limitation) access control, peripheral-system bridge (e.g., AHB-APB bridge, without limitation) access control, bus matrix access control, or a memory protection unit. Specific examples of hardware-based mechanisms of the access control subsystem are discussed below with respect to FIG. 2.

FIG. 2 is a system architecture diagram depicting an example system 200 of a portion of an MCU having a dual-core architecture and integrated access control subsystem, in accordance with one or more examples.

System 200 includes a Core 0 102, a Core 1 128, a bus matrix 202, a memory controller 204, an SRAM C0NTROL0 206, an SRAM C0NTROL1 208, an SRAM0 210, an SRAM1 212, a peripherals 214, a peripherals 216, an APB bridge A 218, an APB bridge B 220, a user data 222, a GPNVM 224, a lock bits 226, a Core 0 FW 228, a Core 1 FW 230, a boot loader 232, a root 234, a set interrupt flag STI 236, factory signals Factory Sig 238, and Call Bits 240.

Core0_control 110 grants or restricts interaction (e.g., by Core 0 102 or Core 1 128, without limitation) via configuration of APB bridges, bus matrices, and memory controllers, discussed below, based on the security policies defined at Core0_control 110 at system boot-up.

APBs and AHBs are respective buses that provide a communication channel between cores and peripheral devices of system 200 and the portion of the MCU more generally. The APB is generally used for connecting lower-speed peripherals, while the AHB is used for high-speed data transmission and connecting major system components such as memory and high-speed peripherals. In one or more examples, access to the peripherals (or the APB bus providing a connection with a peripheral) through the AHB is regulated by bus matrix configurations of bus matrix 202 and Core0_control 110, and access through the APB is regulated by APB bridge configurations of APB bridge A 218 and APB bridge B 220 and Core0_control 110, as discussed below.

APB bridge A 218 and APB bridge B 220 are AHB-APB bridges that interface the higher-speed AHB bus and a lower-speed APB bus, allowing for data transactions between different bus domains. APB bridge A 218 and APB bridge B 220 translates AHB transactions into APB transactions suitable for peripheral communication, and vice-versa. APB bridge A 218 and APB bridge B 220 may be connected to respective subsets of peripherals, including peripherals 214 (here, an APB Bridge A peripheral) and peripherals 216 (here, an APB Bridge B peripheral), with access permissions defined for respective cores (e.g., Core 0 102 and Core 1 128, without limitation) and to prevent access from an unprivileged core. This includes restricting access at the CPUIO peripheral of FIG. 1, more specifically, restricting access to Core0_control 110 to Core 0 102.

Bus matrix 202 is a bus matrix that couples AHB users (e.g., a CPUs and DMAs, without limitation) with AHB targets (e.g., memory and APB bridges, without limitation) and manages the routing of data and control signals therebetween. APB user and target (e.g., peripherals such as peripherals 214 and peripherals 216, without limitation) access to is done via the APB bridges, here APB bridge A 218 and APB bridge B 220. Here, “AHB user” and “APB user” are intended to encompass any user that initiates a communication process on the AHB bus, as the case may be, including users who start a data transaction and control the communication process, or a user that starts a data transaction but does not control the communication process.

Bus matrix 202 is a configurable matrix that may restrict (e.g., physically restrict, logically restrict, or both, without limitation) or allow transactions based on predefined rules aligned with core privileges. In the context of the access control subsystem, bus matrix 202 ensures efficient data flow while enforcing access policies. Specifically, bus matrix 202 is the central switchboard that connects AHB users to AHB targets. Bus matrix 202 handles the routing of transactions and can enforce access control rules set by Core0_control 110. The granularity of configuration and depth of access control provided by bus matrix 202 may depend, as a non-limiting example, on specific operating conditions.

Bus matrix 202 may include one or more mechanisms to restrict user access to targets. As a non-limiting example, bus matrix 202 may include an access control logic to analyze access requests from different cores, including privileged and unprivileged cores, and determine whether to grant or deny the access requests based on pre-set rules. The pre-set rules may be specific to a target, the type of access requested (e.g., read, write, or execute, without limitation), or both. The rules may include permissions for read, write, and execute operations, and may specify which particular memory blocks, peripheral registers, or groups of memory blocks, or groups of peripheral registers, a specific core may interact with.

Bus matrix 202 may include port-based access controls where respective ports on the bus matrix 202 that interfaces with a peripheral or a memory controller may be configured to allow or restrict access. For example, certain ports can be designated only for Core0, while others might be open to all cores but with specific operation restrictions for Core1. In one or more examples that implement port-based access control, some or a totality of port configurations may be static or dynamic. Static port configurations may not be changed. Dynamic port configurations may be dynamically changed by Core 0 102 and Core0_control 110 based on operating conditions (e.g., system states or security requirements, without limitation).

Bus matrix 202 may enable or disable connections between cores and resources physically or logically, for example, by activating or deactivating bus lines or interfaces.

SRAM C0NTROL0 206 and SRAM C0NTROL1 208 are static Random-Access Memory (SRAM) controllers that manage access to SRAM used by the system for, as non-limiting examples, storing data and executing code. In one or more examples, memory partitioning may be applied, with each core having access only to a respective designated SRAM segment, ensuring data isolation between cores. In the specific example depicted by FIG. 2, SRAM C0NTROL0 206 may limit or block access to SRAM0 210 by Core 1 128 based on its access configuration. Meanwhile, SRAM C0NTROL0 206 and SRAM C0NTROL1 208 may allow (e.g., not limit or not block, without limitation) access to SRAM0 210 or SRAM1 212, respectively, by Core 1 128 based on access configurations.

Memory controller 204 is a dedicated controller for non-volatile memory 242, and volatile memory, such as, without limitation, SRAM0 210 and SRAM1 212. In one or more examples, memory controller 204 manage read, write, and erase operations and enforce the memory partitioning directives issued by Core 0 102, preventing Core 1 128 from accessing regions of memory that contain sensitive, critical, or privileged code or data. Access might be differentiated between cores, with Core 0 102 potentially having read-write access while Core 1 128 might be restricted to read-only access.

In one illustrative example, non-volatile memory 242 may include distinct addressable portions, including distinct addressable portions for Core 0 FW 228, Core 1 FW 230, boot loader 232, and root 234. The Core0_control may specify portions (e.g., addresses, without limitation) of root 234 accessible by Corel and specify portions (e.g., addresses, without limitation) of root 234 that are not accessible by Core1.

Non-volatile memory 242 may also include user data 222, GPNVM 224 and lock bits 226. GPNVM 224 are General Purpose Non-Volatile Memory (GPNVM) bits. GPNVM 224 are used in the MCU for storing configuration settings that persist across power cycles and system resets. Lock bits 226 may be used by memory controller 204 to protect firmware or other areas of memory from being, as non-limiting examples, read, written, or erased.

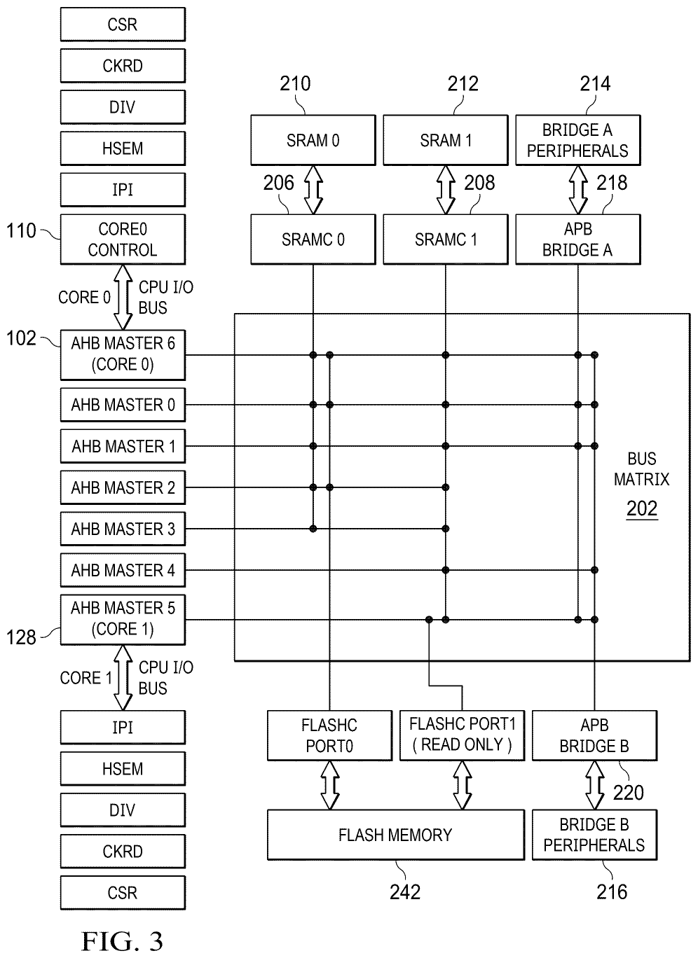

FIG. 3 is a schematic diagram depicting example bus matrix interconnections for access control, in accordance with one or more examples. In one or more examples, specific access control implemented by interconnections of bus matrix 202 may be represented by values in control and status registers of Core0_control 110.

Connections are shown in bus matrix 202, where a solid dot indicates AHB access is allowed by the bus matrix 202. For example, bus matrix 202 allows access by Core 0 102 to AHB port0 203 of memory controller 204 (only AHB port0 203 and AHB port 1 205 of memory controller 204 are depicted in FIG. 3, the rest of memory controller 204 is omitted to avoid unnecessarily obscuring the depiction), SRAM C0NTROL0 206, SRAM C0NTROL1 208, APB bridge A 218 and APB bridge B 220. Bus matrix 202 allows access by Core 1 128 to AHB port1 205 of memory controller 204, SRAM C0NTROL1 208, and APB bridge B 220. Bus matrix 202 does not permit Core 1 128 to access port0 203 of memory controller 204 or SRAM C0NTROL0 206.

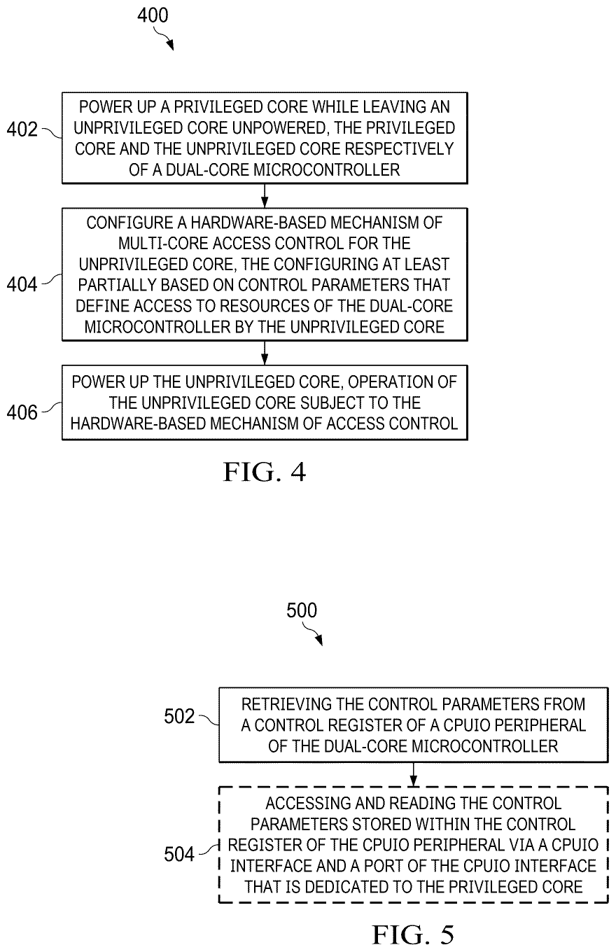

FIG. 4 is a flow diagram depicting an example process 400 to set access control by a processing core of a dual-core microcontroller, in accordance with one or more examples. Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence. Some or a totality of operations of process 400 may be performed, as a non-limiting example, by apparatus 100 or system 200.

According to one or more examples, process 400 may include powering up a privileged core while leaving an unprivileged core unpowered, operation 402. The privileged core and the unprivileged core may respectively be of a dual-core microcontroller. In one or more examples, the privileged core is designated by design as the first core (first in time or order) that executes/boots after reset. Thus, in one or more examples, the privileged core may be designated as such by being the first core (first in time or order) that is powered up at system power on. Upon power up, the privileged core configures the access control and determines the boot order of the unprivileged cores.

According to one or more examples, process 400 may include configuring a hardware-based mechanism of multi-core access control for the unprivileged core, at operation 404. The configuring may be at least partially based on control parameters that define access to resources of the dual-core microcontroller by the unprivileged core. The access defined by the control parameters may include resources of the dual-core microcontroller that the unprivileged core may access and resources of the dual-core microcontroller that the unprivileged core may not access.

According to one or more examples, process 400 may include powering up the unprivileged core, at operation 406. Operation of the unprivileged core is subject to the hardware-based mechanism of access control configured by the privileged core at operation 404. The behavior of the unprivileged core is governed or controlled by the hardware-based access control mechanisms set up by the privileged core. For example, certain acts (e.g., requests to access resources, without limitation) are contingent upon the hardware-based access control mechanisms.

FIG. 5 is a flow diagram depicting an example process 500 to configure a hardware-based mechanism of access control for the unprivileged core based on control parameters, in accordance with one or more examples. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence. Some or a totality of operations of process 500 may be performed, as a non-limiting example, by apparatus 100 or system 200.

According to one or more examples, the process 500 may include receiving the control parameters from control registers of a CPUIO peripheral of the microcontroller at operation 502.

According to one or more examples, process 500 may optionally include accessing and reading the control parameters stored within the control registers of the CPUIO peripheral via a CPUIO interface and a port of the CPUIO interface that is dedicated to the privileged core at operation 504. In one or more examples, the port is dedicated because it is reserved exclusively for use by the privileged core. In some examples, no other cores or system components have access to this particular port for communication or data transactions. In one or more examples, the port may be logically dedicated, physically dedicated, or both. It is logically dedicated if it is reserved via software configuration or system settings (e.g., an access control list or routing table, without limitation). It is physically dedicated if it is hardwired or architecturally designated for use by the privileged core (e.g., actual physical connections or specific hardware configurations that exclusively link the port to a particular component, without limitation).

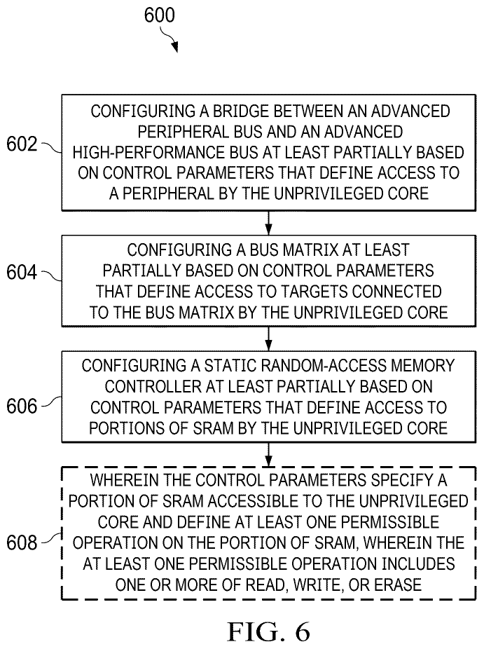

FIG. 6 illustrates an example routine for configuring a hardware-based mechanism of access control at least partially based on control parameters that define access to resources by the unprivileged core, in accordance with one or more examples. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence. Some or a totality of operations of process 600 may be performed, as a non-limiting example, by apparatus 100 or system 200.

According to one or more examples, process 600 may include configuring a bridge between an Advanced Peripheral Bus and an Advanced High-Performance Bus at least partially based on control parameters that define access to a peripheral by the unprivileged core. at operation 602.

According to one or more examples, process 600 may include configuring a bus matrix at least partially based on control parameters that define access to targets (e.g., APB bridges, memories, without limitation) connected to the bus matrix by an unprivileged core at operation 604.

According to one or more examples, process 600 may include configuring a static random-access memory controller at least partially based on control parameters that define access to portions of SRAM by the unprivileged core at operation 606.

According to one or more examples, process 600 may optionally include that the control parameters specify a portion of SRAM accessible to the unprivileged core and define at least one permissible operation on the portion of SRAM, wherein the at least one permissible operation includes one or more of read, write, or erase at operation 608.

Notably, operation 602, operation 604, operation 606, and operation 608 are not mutually exclusive. It is specifically contemplated that in some instances, a subset of the operations of process 600 may be performed to configure multiple hardware-based mechanisms of access control at least partially based on control parameters that define access to resources by the unprivileged core In other instances a totality of the operations of process 600 may be performed to configure multiple hardware-based mechanisms of access control at least partially based on control parameters that define access to resources by the unprivileged core.

The set of hardware registers at the CPUIO peripheral that are dedicated to the privileged core (e.g., Core0_control 110, without limitation) enables controlled access and execution of processes integrated with the registers. In this manner, the dedicated hardware registers facilitate a secure execution zone. Only commands and data from the privileged core can access or modify these hardware registers.

In some examples discussed above, parameters for configuring hardware-based mechanisms of multi-core access control are stored in the secure execution zone so that only a privileged core can retrieve these parameters and configure access control to shared resources of a dual-core microcontroller. A secure execution zone in accordance with one or more examples is not limited solely to implementing access control. Additionally or alternatively, different control and configuration information may be stored at the set of dedicated hardware registers to integrate various functions or processes with the secure execution zone.

As a non-limiting example, control and configuration information for assigning resources to cores, such as interrupts, hardware semaphores, or general-purpose input/output (GPIO), may be stored at the set of dedicated hardware registers at the CPUIO peripheral. The information may be retrieved by a privileged core and transferred from the privileged core to an unprivileged core via inter-processor communication.

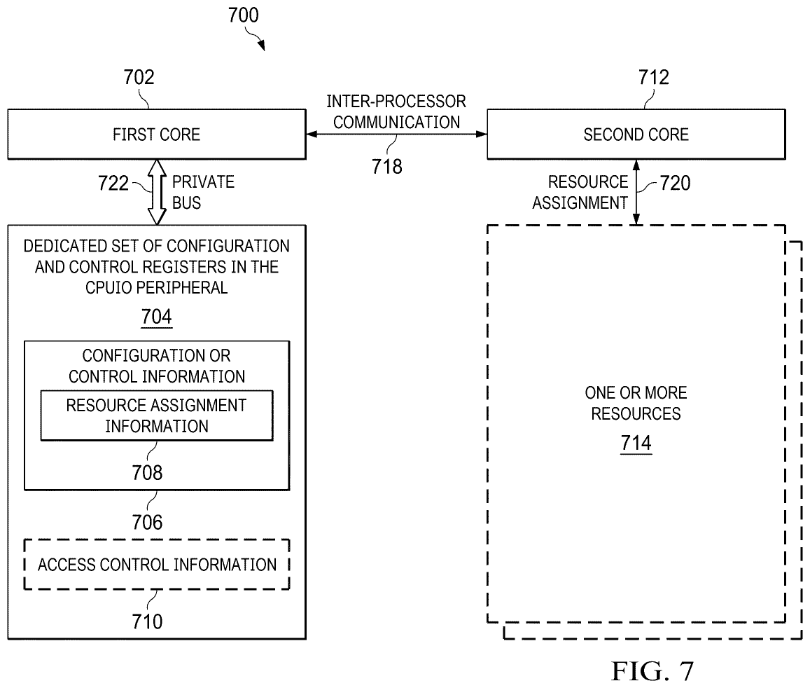

FIG. 7 is a block diagram depicting a system 700 implementing a secure execution zone, in accordance with one or more examples.

System 700 includes a first core 702, a dedicated set of configuration and control registers in the CPUIO peripheral 704, a configuration or control information 706, a resource assignment information 708, an access control information 710, a second core 712, a one or more resources 714, an inter-processor communication 718, a resource assignment 720, and a private bus 722.

First core 702 and second core 712 are processing cores such as central processing unit (CPU). Dedicated set of configuration and control registers in the CPUIO peripheral 704 are a set hardware registers in a CPUIO peripheral. The hardware registers are dedicated to first core 702. Specifically, the hardware registers are accessible only through a private bus 722 connected exclusively to first core 702. This exclusive connection (e.g., dynamic (logical) or static (physical) connection, without limitation) ensures that only commands and data from first core 702 can access or modify the contents of these hardware registers. Private bus 722 is a communication pathway between first core 702 and dedicated set of configuration and control registers in the CPUIO peripheral 704 that is exclusively available to, and used by, first core 702.

First core 702 and second core 712 communicate via inter-processor communication 718 techniques that enable data transfer and signaling. Non-limiting examples of inter-processor communication 718 may include: shared memory accessible by first core 702 and dedicated set of configuration and control registers in the CPUIO peripheral 704, message passing via a direct processor-to-processor connection, pipes, or sockets for unidirectional or bidirectional communication links between processors, or signals and interrupts.

In a specific non-limiting example, second core 712 manages (e.g., performs resource assignment 720, without limitation) on one or more resources 714 of the dual-core processor based on resource assignment information 708 in configuration or control information 706 stored at dedicated set of configuration and control registers in the CPUIO peripheral 704

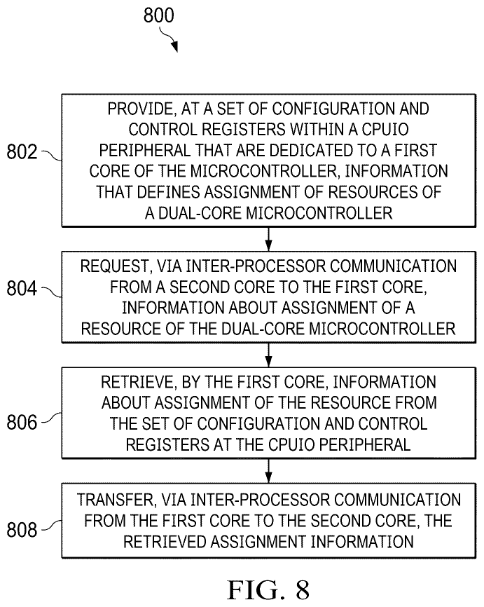

FIG. 8 illustrates an example process 800 for resource assignment integrated with a secure execution zone, in accordance with one or more examples. Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

According to some examples, the method includes providing, at a set of configuration and control registers within a CPUIO peripheral that are dedicated to a first core of the microcontroller, information that defines assignment of resources of a dual-core microcontroller at operation 802.

According to one or more examples, the method includes requesting, by a second core via inter-processor communication, information about assignment of a resource of the dual-core microcontroller at operation 804.

According to one or more examples, the method includes retrieving, by the first core, information about assignment of the resource from the set of configuration and control registers at the CPUIO peripheral, at operation 806.

According to one or more examples, the method includes sending, by the first core via inter-processor communication, the retrieved assignment information to the second core at operation 808.

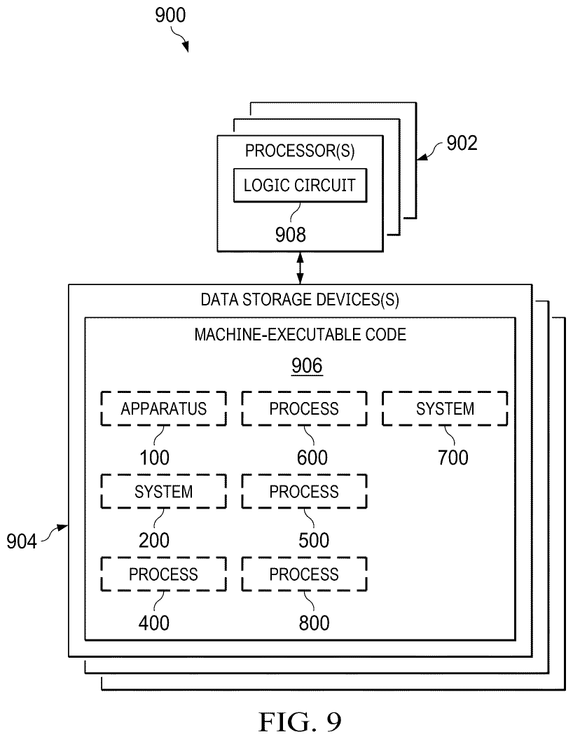

It will be appreciated by those of ordinary skill in the art that functional elements of examples disclosed herein (e.g., functions, operations, acts, processes, or methods) may be implemented in any suitable hardware, software, firmware, or combinations thereof. FIG. 9 illustrates non-limiting examples of implementations of functional elements disclosed herein. In some examples, some or all portions of the functional elements disclosed herein may be performed by hardware capable of carrying out the functional elements.

FIG. 9 is a block diagram of a circuitry 900 that, in some examples, may be used to implement various functions, operations, acts, processes, or methods disclosed herein. The circuitry 900 includes one or more processors 902 (sometimes referred to herein as “processors 902”) operably coupled to one or more data storage devices 904 (sometimes referred to herein as “storage 904”). The storage 904 includes machine-executable code 906 stored thereon and the processors 902 include logic circuit 908. The machine-executable code 906 includes information describing functional elements that may be implemented by (e.g., performed by) the logic circuit 908. The logic circuit 908 is adapted to implement (e.g., perform) the functional elements described by the machine-executable code 906. The circuitry 900, when executing the functional elements described by the machine-executable code 906, should be considered as special purpose hardware for carrying out functional elements disclosed herein. In one or more examples, the processors 902 may perform the functional elements described by the machine-executable code 906 sequentially, concurrently (e.g., on one or more different hardware platforms), or in one or more parallel process streams.

When implemented by logic circuit 908 of the processors 902, the machine-executable code 906 adapts the processors 902 to perform operations of examples disclosed herein. By way of non-limiting example, the machine-executable code 906 may adapt the processors 902 to perform some or a totality of operations of one or more of: process 400, process 500, process 600, or system 700.

Also, by way of non-limiting example, the machine-executable code 906 may adapt the processors 902 to perform some or a totality of features, functions, or operations disclosed herein for one or more of: apparatus 100 or system 200. More specifically, features, functions, or operations disclosed herein for one or more of: Core 0 102, Core 1 128, CPUIO peripheral 106, CPUIO interface 108, CPUIO Interface 138, Core0_Control 110, CPUIO_CSR 112, CPUIO_CSR 132, CPUIO_IPI_0A 114, CPUIO_IPI_0B 116, CPUIO_IPI_1A 118, CPUIO_IPI_1B 120, CPUIO_HSEM 122, CPUIO_DIV 124, CPUIO_DIV 134, CPUIO_CKRD 126, and CPUIO_CKRD 136; system 700 including first core 702, dedicated set of configuration and control registers in the CPUIO peripheral 704, configuration or control information 706, resource assignment information 708, access control information 710, second core 712, one or more resources 714, inter-processor communication 718, resource assignment 720, or private bus 722.

The processors 902 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device (PLD), discrete gate or transistor logic, discrete hardware components, other programmable device, or any combination thereof designed to perform the functions disclosed herein. A general-purpose computer including one or more processors 902, including a general-purpose processor, is considered a special-purpose computer at least while the general-purpose computer executes functional elements corresponding to the machine-executable code 906 (e.g., software code, firmware code, configuration data, hardware descriptions, without limitation) related to examples of the present disclosure. It is noted that a general-purpose processor (which may also be referred to herein as a host processor or simply a host) may be a microprocessor, but in the alternative, a general-purpose processor of processors 902 may include any conventional processor, controller, microcontroller, or state-machine. An FPGA or other PLD of the processors 902 may be configured (e.g., programmed, without limitation) with configuration data to perform functions disclosed herein, or, additionally or alternatively, may be capable of being configured or re-configured (e.g., programmable, or re-programmable, without limitation) with configuration data to perform functions disclosed herein. The processors 902 may also be implemented as a combination of computing devices, such as a combination of a DSP and a microprocessor, a plurality of microprocessors, one or more microprocessors in conjunction with a DSP core, or any other such configuration.

In one or more examples the storage 904 includes volatile data storage (e.g., random-access memory (RAM), static RAM (SRAM), without limitation), non-volatile data storage (e.g., Flash memory, a hard disc drive, a solid-state drive, erasable programmable read-only memory (EPROM), without limitation). In some examples the processors 902 and the storage 904 may be implemented into a single device (e.g., a semiconductor device product, a system on chip (SOC), without limitation). In some examples the processors 902 and the storage 904 may be implemented into separate devices.

In one or more examples the machine-executable code 906 may include computer-readable instructions (e.g., software code, firmware code). By way of non-limiting example, the computer-readable instructions may be stored by the storage 904, accessed directly by the processors 902, and executed by the processors 902 using at least the logic circuit 908. Also, by way of non-limiting example, the computer-readable instructions may be stored on the storage 904, transferred to a memory device (not shown) for execution, and executed by the processors 902 using at least the logic circuit 908. Processors 902 or logic circuit 908 thereof be coupled to such a memory device or include such a memory device (e.g., a configuration memory cell, without limitation). Accordingly, in some examples the logic circuit 908 includes electrically configurable logic circuit 908.

In one or more examples the machine-executable code 906 may describe hardware (e.g., circuitry) to be implemented in the logic circuit 908 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very-large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 908 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 906 may include an HDL, an RTL, a GL description, a mask level description, other hardware description, or any combination thereof.

In examples where the machine-executable code 906 includes a hardware description (at any level of abstraction), a system (not shown, but including the storage 904) implements the hardware description described by the machine-executable code 906. By way of non-limiting example, the processors 902 may include a programmable logic device (e.g., an FPGA or a PLC, without limitation) and the logic circuit 908 may be electrically controlled (e.g., via configuration data, without limitation) to implement circuitry corresponding to the hardware description into the logic circuit 908. Also, by way of non-limiting example, the logic circuit 908 may include hard-wired logic manufactured by a manufacturing system (not shown, but including the storage 904) according to the hardware description of the machine-executable code 906.

Regardless of whether the machine-executable code 906 includes computer-readable instructions or a hardware description, the logic circuit 908 is adapted to perform the functional elements described by the machine-executable code 906 when implementing the functional elements of the machine-executable code 906. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: A method, comprising: powering up a privileged core while leaving an unprivileged core unpowered, the privileged core and the unprivileged core respectively of a dual-core microcontroller; configuring a hardware-based mechanism of multi-core access control for the unprivileged core, the configuring at least partially based on control parameters that define access to resources of the dual-core microcontroller by the unprivileged core; and powering up the unprivileged core, operation of the unprivileged core subject to the hardware-based mechanism of access control.

Example 2: The method according to Example 1, retrieving the control parameters from a control register of a CPUIO peripheral of the dual-core microcontroller.

Example 3: The method according to any of Examples 1 and 2, wherein retrieving the control parameters from control registers of the CPUIO peripheral of the dual-core microcontroller comprises: accessing and reading the control parameters stored within the control registers of the CPUIO peripheral via a CPUIO interface and a port of the CPUIO interface that is dedicated to the privileged core.

Example 4: The method according to any of Examples 1 through 3, wherein configuring the hardware-based mechanism of access control for the unprivileged core comprises: configuring a bridge between a peripheral bus and a system bus at least partially based on control parameters that define access to a peripheral connected to the system bus.

Example 5: The method according to any of Examples 1 through 4, wherein configuring the hardware-based mechanism of access control for the unprivileged core comprises: configuring a bus matrix at least partially based on control parameters that define access to targets connected to the bus matrix by the unprivileged core.

Example 6: The method according to any of Examples 1 through 5, wherein configuring the hardware-based mechanism of access control for the unprivileged core comprises: configuring a memory protection unit at least partially based on control parameters that define access to regions of memory by the unprivileged core.

Example 7: The method according to any of Examples 1 through 6, wherein configuring the hardware-based mechanism of access control for the unprivileged core comprises: configuring a Static Random-Access Memory controller at least partially based on control parameters that define access to portions of SRAM by the unprivileged core.

Example 8: The method according to any of Examples 1 through 7, wherein the control parameters specify a portion of SRAM accessible to the unprivileged core and define at least one permissible operation on the portion of SRAM, wherein the at least one permissible operation includes one or more of read, write, or erase.

Example 9: A CPUIO peripheral of a dual-core microcontroller system, the CPUIO peripheral comprising: a configuration and control register to store control parameters that define access to resources of the dual-core microcontroller system; and a CPUIO peripheral interface including a first port, wherein the control parameters stored at the control register are retrievable from the CPUIO peripheral exclusively via the first port of the CPUIO peripheral interface.

Example 10: The CPUIO peripheral according to Example 9, wherein the CPUIO peripheral interface includes a second port, wherein the control parameters stored at the control register are not retrievable from the CPUIO peripheral via the second port of the CPUIO peripheral interface.

Example 11: The CPUIO peripheral according to any of Examples 9 and 10, comprising one or more further control registers at least some of which are accessible via the first port of the CPUIO peripheral interface and at least some of which are accessible via the second port of the CPUIO peripheral interface.

Example 12: The CPUIO peripheral according to any of Examples 9 through 11, wherein the one or more further control registers include: a control and status register of a processing core coupled to the first port; a control and status register of a processing core coupled to the second port; and control registers for one or more of: hardware semaphores or Inter-Processor Interrupts, respectively of the dual-core microcontroller system.

Example 13: A system, comprising: a first core; a second core; a bus matrix; a bus system integrated with the bus matrix, the bus system comprising: a first bus; a second bus; and a bridge to interface the first bus with the second bus; a CPUIO peripheral; and an access control subsystem integrated with the first core, the bus matrix, the bus system, and the CPUIO peripheral, the access control subsystem to manage interaction of the second core with shared resource.

Example 14: The system according to Example 13, wherein the first core to configure one or more of the bus matrix or the access control subsystem to control access by the second core to resources, the configuring at least partially based on a control parameter of the access control subsystem.

Example 15: The system according to any of Examples 13 and 14, wherein the control parameter of the access control subsystem is stored at the CPUIO peripheral, wherein the control parameter defines access to resources by the second core.

Example 16: The system according to any of Examples 13 through 15, wherein the CPUIO peripheral allows access to the control parameter of the access control subsystem by the first core, and restricts access to the control parameter of the access control subsystem by the second core.

Example 17: The system according to any of Examples 13 through 16, wherein respective control and status registers of the first core and the second core are within the CPUIO peripheral.

Example 18: The system according to any of Examples 13 through 17, wherein control registers for hardware semaphores and Inter-Processor Interrupts are within the CPUIO peripheral.

Example 19: The system according to any of Examples 13 through 18, comprising a memory protection unit, wherein the access control subsystem is further integrated with the memory protection unit.

Example 20: The system according to any of Examples 13 through 19, comprising a memory, wherein the first core to configure the memory protection unit to set access control to regions of the memory by the second core.

Example 21: A system, comprising: a first core; a second core; and a CPUIO peripheral coupled to the first core and to the second core, wherein the second core to request information about assignment of resources of a dual-core microcontroller from the first core via inter-process communication, and wherein the first core to: retrieve assignment information from a set of configuration and control registers at the CPUIO peripheral, the set of configuration and control registers dedicated to the first core; and send the retrieved assignment information to the second core via inter-process communication.

Example 22: The system according to Example 21, the set of configuration and control registers is dedicated to the first core via a private bus that connects the first core and the CPUIO peripheral.

Example 23: The system according to any of Examples 21 and 22, wherein the private bus is a bus that exclusively connects core0 to a port of the CPUIO peripheral for a bus system and the port exclusively has communication access with the set of configuration and control registers dedicated to the first core.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method, comprising:
powering up a privileged core while leaving an unprivileged core unpowered, the privileged core and the unprivileged core respectively of a dual-core microcontroller;
configuring a hardware-based mechanism of multi-core access control for the unprivileged core, the configuring at least partially based on control parameters that define access to resources of the dual-core microcontroller by the unprivileged core; and
powering up the unprivileged core, operation of the unprivileged core subject to the hardware-based mechanism of access control.

2. The method of claim 1, retrieving the control parameters from a control register of a CPUIO peripheral of the dual-core microcontroller.

3. The method of claim 2, wherein retrieving the control parameters from control registers of the CPUIO peripheral of the dual-core microcontroller comprises:
accessing and reading the control parameters stored within the control registers of the CPUIO peripheral via a CPUIO interface and a port of the CPUIO interface that is dedicated to the privileged core.

4. The method of claim 1, wherein configuring the hardware-based mechanism of access control for the unprivileged core comprises:
configuring a bridge between a peripheral bus and a system bus at least partially based on control parameters that define access to a peripheral connected to the system bus.

5. The method of claim 1, wherein configuring the hardware-based mechanism of access control for the unprivileged core comprises:
configuring a bus matrix at least partially based on control parameters that define access to targets connected to the bus matrix by the unprivileged core.

6. The method of claim 1, wherein configuring the hardware-based mechanism of access control for the unprivileged core comprises:
configuring a memory protection unit at least partially based on control parameters that define access to regions of memory by the unprivileged core.

7. The method of claim 1, wherein configuring the hardware-based mechanism of access control for the unprivileged core comprises:
configuring a Static Random-Access Memory controller at least partially based on control parameters that define access to portions of SRAM by the unprivileged core.

8. The method of claim 7, wherein the control parameters specify a portion of SRAM accessible to the unprivileged core and define at least one permissible operation on the portion of SRAM, wherein the at least one permissible operation includes one or more of read, write, or erase.

9. A CPUIO peripheral of a dual-core microcontroller system, the CPUIO peripheral comprising:
a configuration and control register to store control parameters that define access to resources of the dual-core microcontroller system; and
a CPUIO peripheral interface including a first port, wherein the control parameters stored at the control register are retrievable from the CPUIO peripheral exclusively via the first port of the CPUIO peripheral interface.

10. The CPUIO peripheral of claim 9, wherein the CPUIO peripheral interface includes a second port, wherein the control parameters stored at the control register are not retrievable from the CPUIO peripheral via the second port of the CPUIO peripheral interface.

11. The CPUIO peripheral of claim 10, comprising one or more further control registers at least some of which are accessible via the first port of the CPUIO peripheral interface and at least some of which are accessible via the second port of the CPUIO peripheral interface.

12. The CPUIO peripheral of claim 11, wherein the one or more further control registers include:
a control and status register of a processing core coupled to the first port;
a control and status register of a processing core coupled to the second port; and
control registers for one or more of: hardware semaphores or Inter-Processor Interrupts, respectively of the dual-core microcontroller system.

13. A system, comprising:
a first core;
a second core;
a bus matrix;
a bus system integrated with the bus matrix, the bus system comprising:
a first bus;
a second bus; and
a bridge to interface the first bus with the second bus;
a CPUIO peripheral; and
an access control subsystem integrated with the first core, the bus matrix, the bus system, and the CPUIO peripheral, the access control subsystem to manage interaction of the second core with shared resource.

14. The system of claim 13, wherein the first core to configure one or more of the bus matrix or the access control subsystem to control access by the second core to resources, the configuring at least partially based on a control parameter of the access control subsystem.

15. The system of claim 14, wherein the control parameter of the access control subsystem is stored at the CPUIO peripheral, wherein the control parameter defines access to resources by the second core.

16. The system of claim 14, wherein the CPUIO peripheral allows access to the control parameter of the access control subsystem by the first core, and restricts access to the control parameter of the access control subsystem by the second core.

17. The system of claim 13, wherein respective control and status registers of the first core and the second core are within the CPUIO peripheral.

18. The system of claim 13, wherein control registers for hardware semaphores and Inter-Processor Interrupts are within the CPUIO peripheral.

19. The system of claim 13, comprising a memory protection unit, wherein the access control subsystem is further integrated with the memory protection unit.

20. The system of claim 19, comprising a memory, wherein the first core to configure the memory protection unit to set access control to regions of the memory by the second core.

21. A system, comprising:
a first core;
a second core; and
a CPUIO peripheral coupled to the first core and to the second core,
wherein the second core to request information about assignment of resources of a dual-core microcontroller from the first core via inter-process communication, and
wherein the first core to:
retrieve assignment information from a set of configuration and control registers at the CPUIO peripheral, the set of configuration and control registers dedicated to the first core; and
send the retrieved assignment information to the second core via inter-process communication.

22. The system of claim 21, the set of configuration and control registers is dedicated to the first core via a private bus that connects the first core and the CPUIO peripheral.

23. The system of claim 22, wherein the private bus is a bus that exclusively connects core0 to a port of the CPUIO peripheral for a bus system and the port exclusively has communication access with the set of configuration and control registers dedicated to the first core.
